(19) United States
(12) Patent Application Publication
(10) Pub. No.: US 2014/0096591 A1
(43) Pub. Date: Apr. 10, 2014

(54) Ultrasonic Tools for Detection of Gasoline/Ethanol Phase Separation

(71) Applicants: Joe Caldwell, Loomis, CA (US); Howard Dockery, Dallas, TX (US); Dinesh Kumar, Dallas, TX (US); Sidney Durham, Richardson, TX (US)

(72) Inventors: Joe Caldwell, Loomis, CA (US); Howard Dockery, Dallas, TX (US); Dinesh Kumar, Dallas, TX (US); Sidney Durham, Richardson, TX (US)

(21) Appl. No.: 13/646,398

(22) Filed: Oct. 5, 2012

(51) Int. Cl. G01N 29/34

(52) U.S. Cl. CPC G01N 29/34
USPC 73/24.01

(57) ABSTRACT

A method to detect a phase separation of gasoline and ethanol may include the steps of generating a sound signal in a tank, determining a speed of the sound signal, determining an interface level in the tank, determining the speed of the sound signal below the interface level and determining the phase separation based upon the speed of the sound signal.

### FIELD OF THE INVENTION

The present invention relates to a device and method of detecting the separation of gas and ethanol.

### BACKGROUND

Today's gasoline is mixed with ethanol (alcohol) to create a fuel that burns cleaner than 100 percent gasoline. Water ingress into a fuel tank, above-ground or underground, causes the ethanol and water to combine and drop to the bottom of the tank. The combination of water and ethanol in gasoline is known as phase separation. Fuel is pumped from the lower part of the tank and if sufficient phase separation is present, it will be dispensed into a vehicle.

Phase separation has been shown to damage fuel dispensing equipment and motor vehicle fuel systems, including hoses and gaskets. The corrosive phase separation mixture costs the owner for equipment repairs/replacement, pump-outs and stalled vehicles on the forecourt. Leaking hoses and gaskets create a maintenance cost issue and a safety concern because the leaking fuel may catch fire. There exists a need to determine phase separation at the earliest possible time to minimize damage. Early detection can prevent equipment and environmental damage.

The addition of ethanol in various concentrations to gasoline has occurred over the past 10 years. It is now in many brands of gasoline in the USA and around the world. One method has been to use floats that have the density calibrated so that only one floats on water and other floats are calibrated to only float on phase separation. Neither of the floats will float in gasoline. The position of these floats at the bottom of the tank is determined with electronic sensing. This method of detection of phase separation depends on having a layer of phase separation on top of a water layer at the bottom of the tank and determining that the phase separation float is above the water float. In many cases there is no separate layer of phase separation and water rather they form a mixture. This makes determination that ethanol has separated difficult. The float could be on top of a water layer without any ethanol.

Another method is the use of filters in the fuel delivery system that will restrict flow to a low amount by absorbing water and reducing the filters ability to pass liquids. This method detects water and it may not be the result of phase separation with ethanol mixed with the water.

It is desirable to have a method of phase separation that shows the amount of phase separation in volume and the percent of ethanol in the phase separation layer. The methods mentioned here cannot always determine that a phase separation layer exists or the amount of ethanol in the mixture if it does exist.

### SUMMARY

A method to detect a phase separation of gasoline and ethanol may include the steps of generating a sound signal in a tank, determining a speed of the sound signal, determining an interface level in the tank, determining the speed of the sound signal below the interface level and determining the phase separation based upon the speed of the sound signal.

The step of determining the interface level may include the step of determining only if one interface is detected.

The step of determining the interface level may include the step of determining only if two interface levels are detected.

The method may include the step of determining if water is present.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a flowchart diagram of the present invention;

FIG. 2 illustrates a double barrel ultrasonic probe of the present invention;

FIG. 3 illustrates a single barrel ultrasonic probe of the present invention;

FIG. 4 illustrates a horizontal phase detection probe of the present invention;

FIG. 5 illustrates a block diagram of the present invention.

### DETAILED DESCRIPTION

This phase separation mixture of water and ethanol or water and methanol is chemically bonded and has a measurable speed of sound that is significantly different from the parent gasoline and ethanol. Ultrasonic pulse/sound signal echo detection systems permit detection and location of the fuel and water/ethanol interface. One such embodiment of this electronic device is the tank manager console and probe. The speed of sound is determined in the region below this interface and compared with parent fuel mixture of gasoline and ethanol. The difference in speed of sound from the parent gasoline can be interpreted to show that the mixture at the bottom of the tank contains water and/or ethanol.

These principles have been confirmed with the test results from multiple different samples of gasoline/ethanol blends. These test results and the speed of sound in the mixture of ethanol and water at various percent's of ethanol are included in this patent application.

Test results for gasoline only, diesel, 80 percent ethanol fuel and 98% ethanol fuel are also included in the patent application.

Data received from console to PC is processed for phase separation detection of water and ethanol mixture. If a phase separation is detected, the process will calculate the phase level at the bottom of the tank. Some of the terms used in the documents are C1, C2, and C3 which mean first calibration rod, second calibration rod, and third calibration rod respectively. C1, C2, and C3 have fixed distances from the top of the crystal. For the embodiment used for the test results contained in this patent application: C1 is 10.64 inches, and for double barrel probe C2 and C3 are 26.98 and 41.98 inches from the top of the crystal. Units used for all distances are inches and for speed it is microseconds per inch.

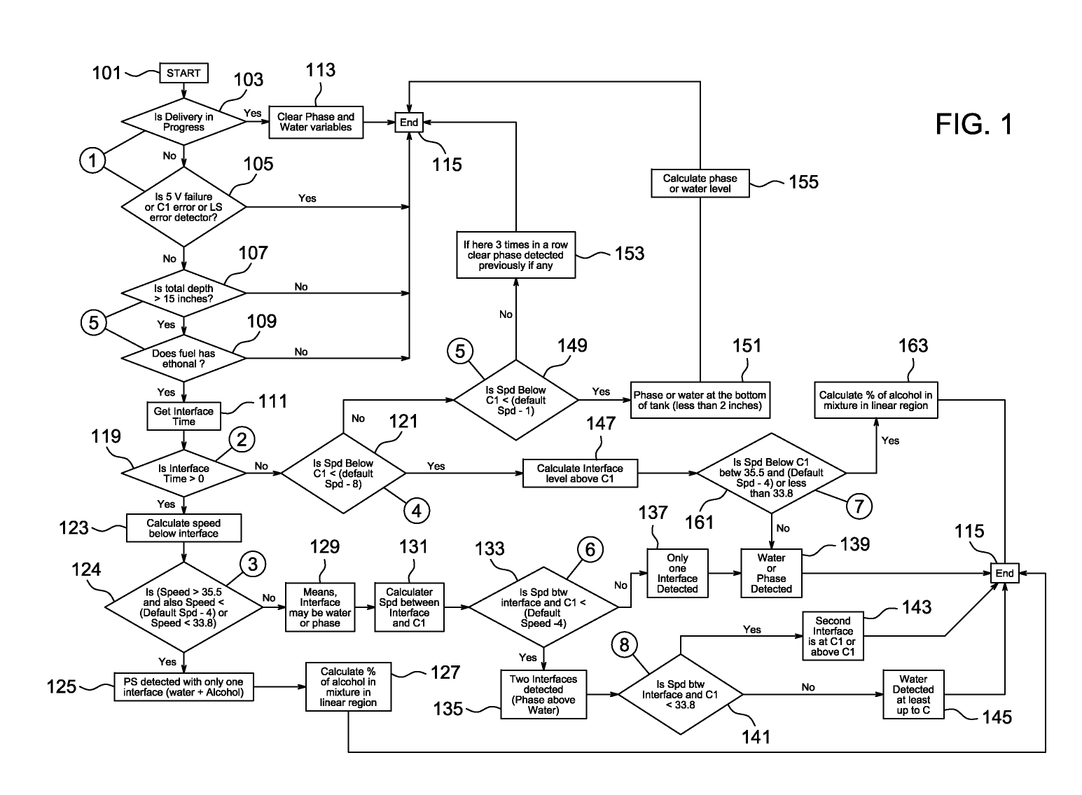

For each time of flight detection data message from the console, error conditions are first checked [1 of FIG. 1]. If an error condition exists or fuel does not contain ethanol or delivery in progress then do not process the data.

If detection time for a possible phase interface or water interface is not zero, [2 of FIG. 1] then the interface location and speed in liquid below the interface is calculated using detection time data for C1, C2 and/or C3 from the message received from controller. This interface detection may be water or phase separation. The equations used are given below and the different possible solutions are represented by a Case number.

The default speed of sound may be calculated depending on the amount of fuel (the fuel level) in the tank. If the fuel level is passed C3 the speed between C1 and C2 and the speed between C2 and C3 is calculated

If the fuel level is passed C2, the speed between C1 and C2 is calculated.

If the fuel level is less than C2 use the previous (last calculation) default speed between C1 and C2 or C2 and C-3. If the previous default speed is not known, then use the default speed for the fuel type.

Basic equations used to start the calculations are as follows:

speed BetwCn−Cn+1 (us/in)=default speed for fuel (us/in)

or if c1,c2 times present calc speed c1−c2: if c3 present use c2−c3

speed BetwCn−Cn+1 (us/in)=[cn+1 det time (us)−cn detection time (us)]/dist from cn to cn+1 (in)

fuelDistanceAboveInterface (in)=[C1 detection time (us)−fuelWaterInterface detection Time(us)]/speed BetwCn−Cn+1 (us/in)

WaterAlcoholDist (in)=C1 distance (in)−fuelDistanceAboveInterface (in)

SpeedBelowInterface (us/in)=FuelWaterInterfaceTime (us)/WaterAlcoholDist (in)

Now each case is described and referred to in the flow chart FIG. 1.

Case 1 Below Interface Speed 35.5 us/in to Default Fuel Speed−4 us/in

If the speed below interface is greater than a nominal 35.5 (us/in) and less than the nominal fuel Cn to Cn+1 speed or default speed (us/in)−4 (us/in) then phase separation is detected (3 of FIG. 1). The depth of the phase separation is computed as follows:

Phase Depth (in)=WaterAlcoholDist (in)+transducer bias (in)

Where transducer bias is distance crystal is off the bottom of tank.

Case 2. Below Interface Speed Less that 33.8 us/in, Calculate Percent Ethanol in Phase Separation

IF the speed calculated below the phase interface detection time is less than a first predetermined time such as 33.8 us then it is phase separation to bottom of tank The relationship of speed to percent ethanol to water is shown in the test data that is part of this patent application. This speed has a linear relationship to percent ethanol to water that terminates at about a second predetermined speed such as 31.5 to 32.5 us/in when completely saturated.

Case 3 Below Interface Speed 34 us/in to 35.5 us/in (Water Only), Calculate Speed from Interface to C1

If the speed is calculated below, the phase interface detection time may be a second predetermined time such as 34 to 35.5 and the fuel has ethanol, then calculate speed from phase interface detection time to C1 as follows:

SpdbetwInterface &C1 (us/in)=[C1 time (us)−fuelWaterInterfaceTime (us)]/[C1 distance (in)−firstInterfacedistance (in)]

Case 3a Speed from First Interface to C1 is 35.5 (us/in) to Default Fuel Speed−4 (us/in)

If this speed is greater than a nominal third predetermined speed such as 35.5 (us/in) and less than the fuel default speed (us/in)−4 (us/in) then phase separation detected (6 of FIG. 1) above the first interface detection (which is water only). The water may in some cases enter the tank from the bottom and not completely interact with the ethanol. This is not likely if tank is active and deliveries are made that result in agitation and mixes the water and ethanol so that only one interface is found. The approximate interface distance may be calculated as follows:

InterfaceDistfrmfirstinterfacedetection={c1dist (in)−firstinterfacedetdist (in)]*SpdbetwInterface&C1 (us/in)/defaultspeed (us/in)

This distance is added to the distance to first interface to show approximate top of both the phase separation and water layers.

Case 3b Speed from First Interface to c1 is Less than 33.8 us/in

If the speed in the second region is less than a fourth predetermined time which may be 33.8 us/in [8 of FIG. 1] then phase separation extends at least to c1. and second interface distance less first interface will be phase separation and first interface is water. This result shows phase separation to c1 and it may extend further but all calculations will stop here.

Case 3c Speed from First Interface to c1 is Between 33.8 us/in and 35.5 us/in

This case is possible if there is an object in probe causing the first reflection and there is water in tank below and above that object. This result shows water to c1 and it may extend further but all calculations will stop here.

Case 4 Interface Time from Data Message is 0 Us

A no detection time [2 of FIG. 1] may indicate to check for phase separation above C1 or at low level very close to the crystal. Speed to c1 is calculated as follows:

SpeedtoC1 (us/in)=c1 time (us)/c1 distance (in)

If speed to c1 is less than default−8

[4 of FIG. 1] may indicate to check for phase separation above C1, close in or water only close in. If phase separation is past c1 calculation as follows:

InterfaceDist=c1distance (in)+[(c1c2distance (in)*c1c2speed (us/in)/defaultspeed (us/in)

If no phase separation past c1 and If speed to c1 is less than default−1, an interface may be close in (less than about 2 inches) [5 of FIG. 1].

The following equation will calculate the position of this interface less than c1 with no interface detection time. This interface may be water or phase separation. The calculation is as follows:

InterfaceDist=c1distance (in)*speedc1 (us/in)/defaultspeed (us/in)

### Case 5 Horizontal Ultrasonic Sensor

For low level detection of phase separation use a sensor that is horizontal as shown in the probe drawings. This will permit detection when tube is half full of phase separation. Speed may be less than a fifth predetermined speed for example 33.8 or 35.5 to 4 less than default.

An ultrasonic electronic device may include a microprocessor, transmitter, receiver, timing circuit, ultrasonic transducer and processing computer are used to detect and calculate the presence of phase separation. An ultrasonic pulse/sound signal is generated by the transmitter and applied to an ultrasonic transducer located in a probe in the fuel tank. This transmitter pulse/sound signal is then converted to a sound wave by the transducer and the sound travels through the fuel. Some of the sound wave energy is reflected at liquid interface boundaries and at fixed calibration rods and at the fuel surface. These reflected energy pulses/sound signals are converted to an electrical signal by the transducer and are processed by the electronic receiver and timing circuit. The calculations based on the timer circuit are use to get the time of flight to each echo. The data is processed for phase separation as shown on the attached flow chart and flow chart description document. The results of these calculations will show if phase separation has occurred and to what degree (percent of ethanol in the ethanol/water mixture).

The schematic that is included in this patent application shows one embodiment of an ultrasonic transmitter and receiver with timing circuitry The embodiment of an electronic circuit design can consist of different components and is not unique for the purpose of this invention for measuring the location of echoes from liquid interfaces and calibration rods. The microprocessor and the software/firmware can also be designed in different embodiments which can accomplish the same results of measuring the time of flight

to phase interface and calibration rods.

This invention depends on the principle that the speed of sound in ethanol and water in their individual states cannot be used to calculate the speed in an ethanol/water mixture that is proportional to the ratio of water to ethanol. The speed of sound in a saturated mixture is less than that of either ethanol or water. In a less than saturated mixture the speed of sound is less than in ethanol and more than in water. Speed also decreases linearly as more water is added until saturation. After complete saturation the speed in the phase separation mix remains almost constant. The speed measurements are used to determine if phase separation has occurred. The results obtained by testing have confirmed these properties and are included in this application. The grade of gasoline (low, mid or high octane) does not make any significant difference in the detection of phase separation or speed calculations.

The chemical interaction of different fluids may well act the same as water and ethanol and the invention may be used to calculate that a chemical interaction has occurred and what percent of each liquid is present in the mixture. The ultrasonic methods here in described can therefore provide a non-destructive method of determination of the composition of the liquid. Some examples but not limited to: water-chlorine concentrations, water-ethanol for liquor alcohol concentrations, water-acids concentrations.

FIG. 1 illustrates a flowchart of the present invention. The flowchart starts at step 101, and control is passed to step 103 where it is determined if delivery of fuel is in progress. If delivery is in progress, control passes to step 113 where the phase and water variables are cleared and set to zero. After step 113, control passes to step 115 and the process stops at step 115. If delivery is not in progress, control passes to step 105 and determines if there has been a 5 V failure, or a C1 error or a level signal to indicate the level of the fluid LS (if there is no level then a problem exists) error detected, if so then control passes to step 115 where the method ends. If there has not been an error from step 105, control passes to step 107 where it is determined if the total depth of the test container is greater than 15 inches and if the total depth is not greater than 15 inches, then control passes to step 115 where the method ends.

If the total depth is greater than 15 inches in step 107, then control passes to step 109 where it is determined if the fuel includes ethanol. If there is no ethanol, then control passes to step 115 where the method ends.

Since the fuel has ethanol, in step 111, the interface time is determined. In step 119, it is determined if the interface time is greater than zero. If the interface time is greater than zero in step 123, the speed is calculated below the interface position. In step 124, it is determined if the speed is greater than 35.5 and also if the speed is less than the default speed−4 or the speed is less than 33.8. If the determination is positive, control passes to step 125 to indicate that phase separation has been detected with only one interface (water and alcohol). In step 127, the percentage of alcohol in mixture is calculated in the linear region and control passes to step 115 to end the method.

If the determination is not met, the interface may be water or phase separation in step 129. In step 131, the speed is calculated between the interface and position C1. Control passes to step 133 where if the speed between the interface and C1 is less than the default speed−4 control passes to step 135, but if the speed between the interface and C1 is greater than or equal to the default speed−4 control passes to step 137. In step 137, only one interface has been detected and control passes to step 139. In step 139, either water or phase separation has been detected. Control passes to step 115 to end the method.

In step 135, it is determined that two interfaces have been detected, one interface is a phase separation above water. Control passes to step 141 where it is determined if the speed between the interface and C1 is less than 33.8. If the speed is less than 33.8 then control passes to step 143 where it is determined that a second interface is at C1 or above C1 and control then passes to step 115 where the method ends.

In step 141, if the speed is greater than or equal to 33.8 then control passes to step 145 where it is determined that water has been detected at least up to C1. Control passes to step 115 where the method ends.

If the speed below C1 is less than the default speed−8 in step 121 then the interface level above C1 is calculated in step 147, and if the speed below C1 is greater than or equal to the default speed−8 in step 21, and control passes to step 149. In step 149, if the speed below C1 is less than the default speed−1 then transfer control to step 151 where the phase separation or water is positioned at the bottom of the tank (less than 2 inches). If the speed below C1 is greater than or equal to the default speed−1 and transfer control to step 153. If step 153 has been executed three times in a row than the phase detected is cleared. From step 153, step 115 which ends the method is executed.

Control from step 151 is transferred to step 155 to calculate the phase separation or water level distance and control is transferred to step 115 to terminate the method.

In step 147, the interface level above C1 is calculated, and control passes to step 161. In step 161, it is determined if the speed below C1 is between 35.5 and the (default speed−4) or less than 33.8. If the determination is that the speed is not between 35.5 and the (default speed−4) or less than 33.8 then control passes to step 139. Otherwise if the determination is that the speed is between 35.5 and the (default speed−4) or less than 33.8 then control is transmitted to step 163 where the percent of alcohol in the mixture in the linear region is calculated. Control passes to step 115 to end the method.

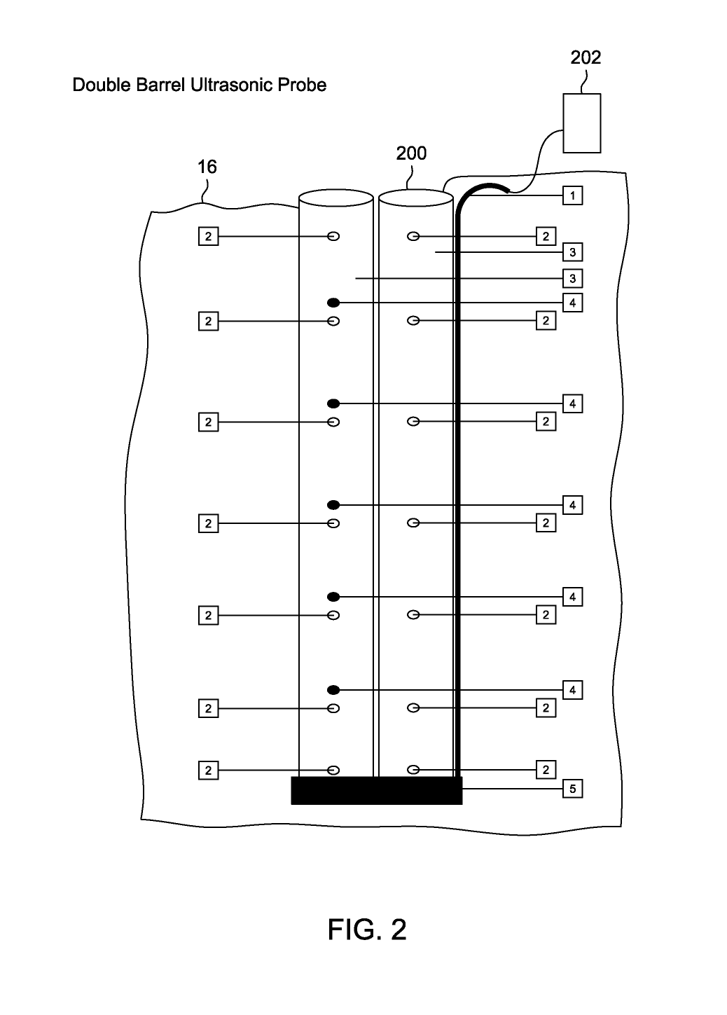

FIG. 2 illustrates a double barrel ultrasonic probe 200 and illustrates a Shielded Wire 1 to connect to the controller 200, Pressure Equalization Holes 2 to equalize the pressure from the tank 202, a Hollow Tube (Extends to top of the Tank) 3 to make measurements from, Calibration Rods which may be brass (Preset Distances from Crystal face) 4 to detect the sound and Ultrasonic Transducer Housing with Crystal 5 to detect the sound and generate a sound signal to be received by the controller 202.

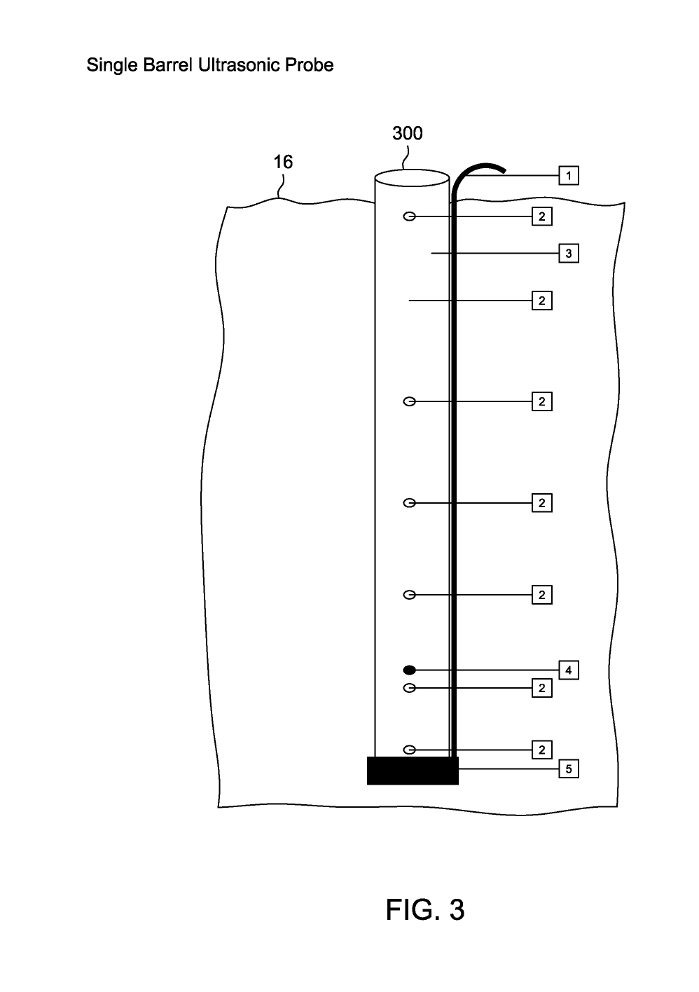

FIG. 3 illustrates a double barrel ultrasonic probe 300 and illustrates a Shielded Wire 1 to connect to the controller 202, a Pressure Equalization Holes 2 to equalize the pressure from the tank 16, a Hollow Tube (Extends to top of the Tank) 3 to make measurements from, Calibration Rods which may be brass (Preset Distances from Crystal face) 4 to detect the sound and Ultrasonic Transducer Housing with Crystal 5 to detect the sound and generate a sound signal to be received by the controller 202.

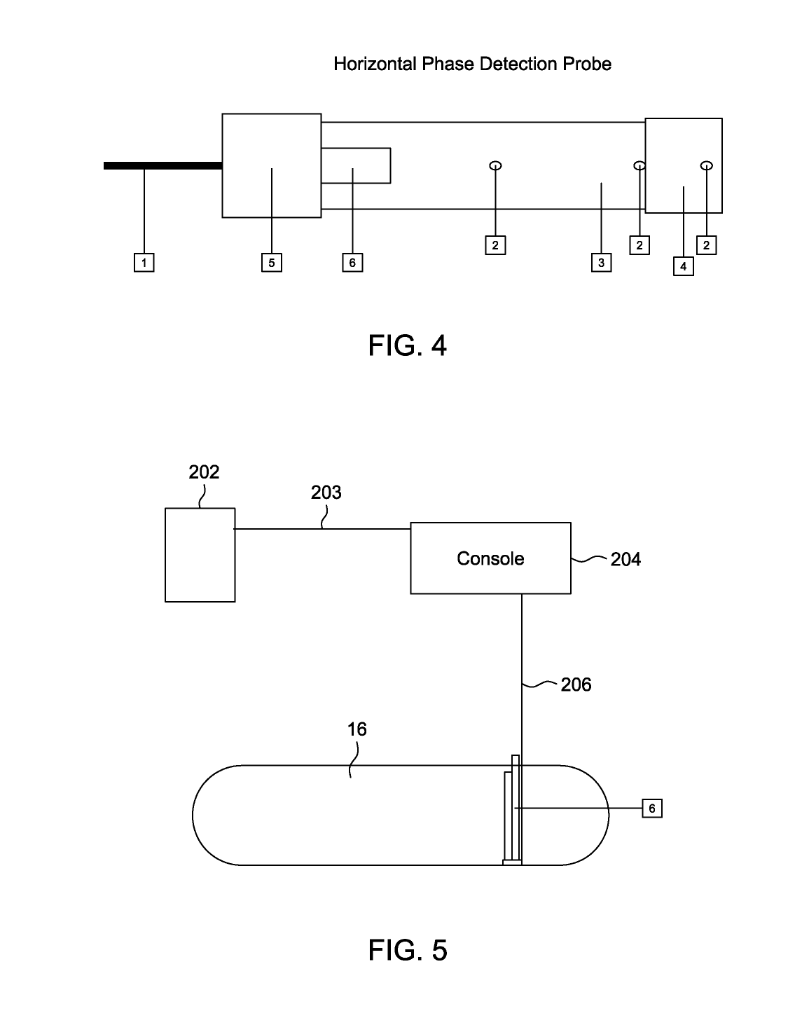

FIG. 4 illustrates a horizontal phase detection probe of the present invention.

FIG. 5 illustrates a block diagram of the present invention. FIG. 5 illustrates a controller 202 which may be an Embedded PC or External PC containing the application Software for processing the time of flight data received from the console, A Data path serial cable 203 may be positioned between the PC 202 and console 204. FIG. 5 additionally illustrates Tank 16 which may include fuel. Console 204 may include a microprocessor and electronics for ultrasonic pulse/sound signal echo generation and connectors for ultrasonic cabling to tank 16. Data is collected and sent to the PC 204 for processing. Homerun Cable(s) 206 carries the transmitted ultrasonic signal from the console 204 to the probe 200 and returning the signal from the probe 200 to the console 204 for detection processing. Ultrasonic probe 200 including one or more hollow tubes and an ultrasonic transducer 5 (Crystal) at the bottom. This transducer 5 includes an ultrasonic crystal which may be potted with epoxy that will withstand fuels. The probe may contain more than one tube with calibration rods in one of them.

The equations and speeds described above may be modified to reflect different mixtures and compositions. The method may be substantially the same by varying the equations in speeds While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method to detect a phase separation of gasoline and ethanol, comprising the steps of:
generating a sound signal in a tank;
determining a speed of the sound signal;
determining an interface level in the tank;
determining the speed of the sound signal below the interface level;
determining the phase separation based upon the speed of the sound signal.

2) A method to detect a phase separation of gasoline and ethanol as in claim 1, wherein the step of determining the interface level includes the step of determining only if one interface is detected.

3) A method to detect a phase separation of gasoline and ethanol as in claim 1, wherein the step of determining the interface level includes the step of determining only if two interface levels are detected.

4) A method to detect a phase separation of gasoline and ethanol as in claim 1, wherein the method includes the step of determining if water is present.
